(19) United States
(12) Patent Application Publication
(10) Pub. No.: US 2025/0020832 A1
(43) Pub. Date: Jan. 16, 2025

(54) LENS ASSEMBLY

(71) Applicant: SAMSUNG ELECTRO-MECHANICS CO., LTD., Suwon-si (KR)

(72) Inventors: Sang Hyuk YUM, Suwon-si (KR); Young Su JIN, Suwon-si (KR); Soo Hyun CHO, Suwon-si (KR)

(73) Assignee: SAMSUNG ELECTRO-MECHANICS CO., LTD., Suwon-si (KR)

(21) Appl. No.: 18/607,911

(22) Filed: Mar. 18, 2024

(30) Foreign Application Priority Data
Jul. 12, 2023 (KR) 10-2023-0090184

(51) Int. Cl. G02B 3/00; G02B 7/02

(52) U.S. Cl. CPC G02B 3/0075; G02B 3/0062; G02B 7/021; G02B 7/028

(57) ABSTRACT

A lens assembly includes a first lens including an optical portion and a flange portion extending therefrom, a second lens disposed on one side of the first lens and a third lens disposed on another side of the first lens in an optical axis direction. The flange portion includes a first groove formed in one surface and a first protrusion disposed on another surface, the second lens includes a second protrusion disposed in the first groove, and the third lens includes a second groove in which the first protrusion is disposed. The second protrusion is spaced apart from an inner surface of the first groove and the first protrusion is spaced apart from an inner surface of the second groove in a direction perpendicular to the optical axis, wherein the inner surface of the first groove is closer to the optical axis than the inner surface of the second groove.

### CROSS-REFERENCE TO RELATED APPLICATIONS

This application claims the benefit under 35 USC 119 (a) of Korean Patent Application No. 10-2023-0090184 filed on Jul. 12, 2023, in the Korean Intellectual Property Office, the entire disclosure of which is incorporated herein by reference for all purposes.

### BACKGROUND

### 1. Field

The present disclosure relates to a lens assembly.

### 2. Description of the Background

Camera modules may be used in portable electronic devices such as smartphones, tablet PCs, and laptops.

To implement high resolution in a camera module, a lens assembly in which multiple lenses are stacked may be used. The lens assembly may be assembled in a lens barrel by aligning optical axes of a plurality of lenses.

Lenses may undergo expansion and contraction due to moisture and heat. The plurality of lenses applied to the lens assembly may have different shapes or be formed of different materials, and amounts of expansion thereof due to moisture and heat may also be different. When a lens with a large expansion amount expands, interference with other lenses may occur, and contact may cause deformation of one or more lenses. When the lenses are deformed due to contact between the lenses, the shape of an optical portion of the lens may change, or the gap between lenses may change, causing a problem in which performance of the lens assembly deteriorates.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens assembly includes a first lens including an optical portion and a flange portion extending from the optical portion, a second lens disposed on one side of the first lens in an optical axis direction, and a third lens disposed on another side of the first lens in the optical axis direction. The flange portion includes a first groove formed in one surface and a first protrusion disposed on another surface, the second lens includes a second protrusion disposed in the first groove, and the third lens includes a second groove in which the first protrusion is disposed. The second protrusion is spaced apart from a portion of an inner surface of the first groove in a first direction, perpendicular to an optical axis, the first protrusion is spaced apart from a portion of an inner surface of the second groove in the first direction, and the portion of the inner surface of the first groove is disposed closer to the optical axis than the portion of the inner surface of the second groove.

The first groove may include a first inner surface and a second inner surface spaced apart in the first direction, and the second protrusion may be disposed to be spaced apart from the first inner surface of the first groove.

The second groove may include a first inner surface and a second inner surface spaced apart in the first direction, and the first protrusion may be disposed to be spaced apart from the second inner surface of the second groove.

The first inner surface of the first groove may be disposed further inwardly of the second inner surface of the second groove in the first direction.

The inner surface of the first groove may include a third inner surface connecting the first inner surface of the first groove and the second inner surface of the first groove, a lower surface of the second protrusion may oppose the third inner surface of the first groove, and the lower surface of the second protrusion may be spaced apart from the third inner surface of the first groove in the optical axis direction.

The first protrusion may have a tapered shape with a width becoming narrower from an object side to an image side.

The first protrusion may include a first outer surface in contact with the second groove, and the first outer surface may form an acute angle with a virtual line parallel to the optical axis.

An amount of expansion of the first lens in the first direction according to a change in temperature or humidity may be greater than an amount of expansion of the second lens and the third lens in the first direction.

The one surface of the flange portion may be an image-side surface, and the other surface of the flange portion may be an object-side surface.

The first groove may include a first inner surface and a second inner surface opposing the first inner surface of the first groove, and the second protrusion may be disposed to be spaced apart from the first inner surface of the first groove in the first direction.

The second groove may include a first inner surface and a second inner surface opposing the first inner surface of the second groove, and the first protrusion may be disposed to be spaced apart from the second inner surface of the second groove in the first direction.

The first protrusion may have a tapered shape with a width becoming narrower from an image side to an object side.

The first lens may include an upper first lens and a lower first lens stacked.

In another general aspect, a lens assembly includes a lens barrel, a first lens including an optical portion and a flange portion extending from the optical portion, a second lens disposed on one side of the first lens in an optical axis direction, and a third lens disposed on another side of the first lens in the optical axis direction. The flange portion includes a first groove formed in one surface and a first protrusion disposed on another surface, the second lens includes a second protrusion disposed in the first groove, the third lens includes a second groove in which the first protrusion is disposed, the first groove includes a first inclined surface spaced apart from the second protrusion in a first direction, perpendicular to an optical axis, the second groove includes a second inclined surface spaced apart from the first protrusion in the first direction, and the first inclined surface of the first groove and the second inclined surface of the second groove have inclined directions opposite to each other based on a line, parallel to the optical axis.

An outer peripheral surface of the first lens may be spaced apart from an inner peripheral surface of the lens barrel.

The first lens may be configured to expand in the first direction according to a change in temperature or humidity such that the outer peripheral surface of the first lens contacts the inner peripheral surface of the lens barrel.

The first lens may be configured to expand in the first direction according to a change in temperature or humidity such that the first protrusion contacts the second inclined surface of the second groove.

Other features and aspects will be apparent from the following detailed description, the drawings, and the claims.

### BRIEF DESCRIPTION OF DRAWINGS

FIG. 1 is a cross-sectional view of a lens module to which a lens assembly according to an embodiment is applied.

FIG. 2 is an enlarged view of A in FIG. 1 when the lens is not expanded.

FIG. 3 is an enlarged view of A in FIG. 1 when the lens is expanded.

FIG. 4 is an enlarged view of portions of a first lens and a second lens when the first lens is not expanded.

FIG. 5 is a greater enlarged view of portions of the first lens and the second lens when the first lens is not expanded.

FIG. 6 is a cross-sectional view of a lens module to which a lens assembly according to another embodiment is applied.

FIG. 7 is an enlarged view of B of FIG. 6 when the lens is not expanded.

FIG. 8 is a cross-sectional view of a lens module to which a lens assembly according to another embodiment is applied.

FIG. 9 is an enlarged view of C in FIG. 8 when the lens is not expanded.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

An aspect of the present disclosure may provide a lens assembly in which lens deformation due to contact between lenses based on expansion of the lenses may be significantly reduced.

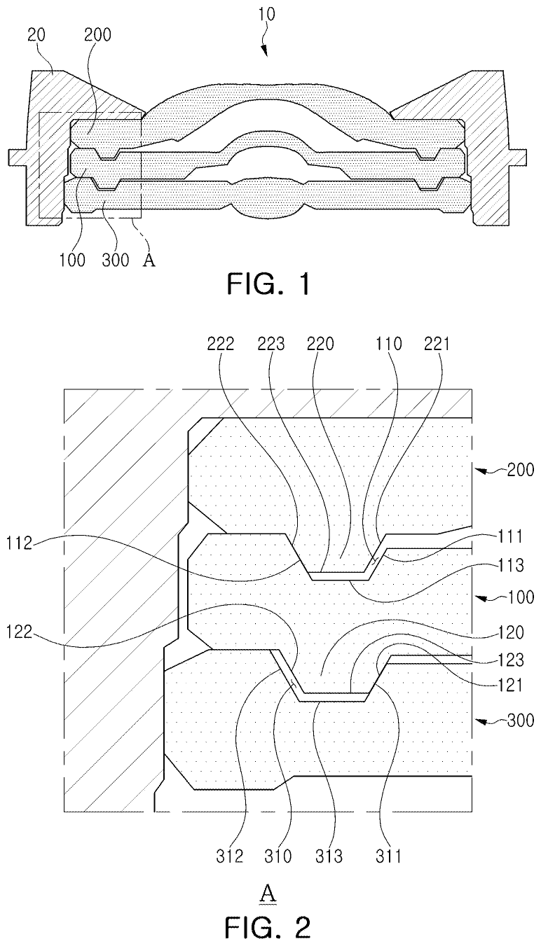

FIG. 1 is a cross-sectional view of a lens module to which a lens assembly according to an embodiment is applied, and FIG. 2 is an enlarged view of A in FIG. 1 when the lens is not expanded.

Referring to FIG. 1, a lens module to which a lens assembly according to an embodiment is applied may include a lens assembly and a lens barrel. The lens assembly may include a plurality of lenses that are stacked.

Referring to FIG. 1, a lens assembly 10 is illustrated as being comprised of three lenses, but the spirit of the present disclosure is not limited to the number of lenses. For example, depending on the resolution to be implemented, the lens assembly may be comprised of three lenses or may include four or more lenses.

A first lens 100, a second lens 200, and a third lens 300 may be disposed inside a lens barrel 20. The lens barrel 20 may accommodate the lens assembly 10 including the first lens 100, the second lens 200, and the third lens 300.

The second lens 200 may be placed above the first lens 100. The third lens 300 may be placed below the first lens 100.

The first lens 100, the second lens 200, and the third lens 300 may each include an optical portion and a flange portion. The optical portion may be an area that refracts light passing through the lens. The optical portions of the respective first lens 100, second lens 200, and third lens 300 may have different refractive indices. The optical portions of the respective first lens 100, second lens 200, and third lens 300 may be disposed to be spaced apart in the optical axis direction. The flange portion may be formed by extending from the optical portion. The flange portion may be formed to extend from the outer peripheral surface of the optical portion. The flange portion may support the lens assembled to the lens barrel. At least portions of respective flange portions of the first lens 100, the second lens 200, and the third lens 300 may be in contact.

Referring to FIG. 2, the first lens 100 may include a first groove 110 and a first protrusion 120. The first groove 110 may be disposed on one surface of the flange portion, and the first protrusion 120 may be disposed on the other surface of the flange portion. In this case, the one surface of the flange portion may be the upper surface of the flange portion, and the other surface of the flange portion may be the lower surface of the flange portion.

The first groove 110 may have a trapezoidal shape in a cross-section parallel to the optical axis. The first groove 110 may become narrower in width from the one surface of the flange portion toward the other surface. The width of the first groove 110 may become narrower from the object side to the image side. The first groove 110 may have a tapered shape of which a width becomes narrower from the one surface of the flange portion toward the other surface.

The first groove 110 may include a first inner surface 111 and a second inner surface 112. The first inner surface 111 and the second inner surface 112 may be side surfaces of the first groove 110. The first inner surface 111 may be disposed opposite to the second inner surface 112. The first inner surface 111 may be disposed to overlap the second inner surface 112 in a first direction perpendicular to the optical axis. The first inner surface 111 and the second inner surface 112 may be inclined surfaces. The first inner surface 111 may be an inclined surface of which a distance from the optical axis increases as it extends from the one surface of the flange portion to the other surface. The second inner surface 112 may be an inclined surface of which a distance from the optical axis becomes shorter as it extends from the one surface of the flange portion to the other surface.

The first groove 110 may include a third inner surface 113. The third inner surface 113 may be the lower surface of the first groove 110. The third inner surface 113 may be a surface connecting the first inner surface 111 and the second inner surface 112. The third inner surface 113 may be flat. The third inner surface 113 may be a plane perpendicular to the optical axis.

The first protrusion 120 may have a trapezoidal cross-section, parallel to the optical axis. The first protrusion 120 may become narrower in width in a direction from the one surface of the flange portion toward the other surface. The width of the first protrusion 120 may become narrower in a direction from the object side to the image side. The first protrusion 120 may have a tapered shape whose width becomes narrower in a direction from the one surface of the flange portion toward the other surface. The first protrusion 120 may include a first outer surface 121 and a second outer surface 122. The first outer surface 121 and the second outer surface 122 may be side surfaces of the first protrusion 120. The first outer surface 121 may be disposed opposite to the second outer surface 122. The first outer surface 121 may overlap the second outer surface 122 in a first direction perpendicular to the optical axis. The first outer surface 121 and the second outer surface 122 may be inclined surfaces. The distance of the first outer surface 121 from the optical axis may increase as it extends in a direction from the one surface of the flange portion to the other surface. The distance of the second outer surface 122 from the optical axis may become shorter as it extends in a direction from the one surface of the flange portion to the other surface.

The first inner surface 111 of the first groove 110 may be disposed to be spaced apart from the second outer surface 122 of the first protrusion 120 in the first direction. The first inner surface 111 of the first groove 110 may be disposed further inwardly than the second outer surface 122 of the first protrusion 120, based on the first direction.

The first protrusion 120 may include a third outer surface 123. The third outer surface 123 may be a surface connecting the first outer surface 121 and the second outer surface 122. The third outer surface 123 may be a plane perpendicular to the optical axis.

Referring to FIGS. 1 and 2, the second lens 200 may be disposed above the first lens 110. The second lens 200 may include an optical portion and a flange portion extending from the optical portion. At least a portion of the flange portion of the second lens 200 may contact the flange portion of the first lens 100. At least a portion of the lower surface of the flange portion of the second lens 200 may be in contact with the upper surface of the flange portion of the first lens 100. In this case, the lower surface of the flange portion may be the surface closest to the first lens 100 among one surface and the other surface of the second flange portion. The flange portion of the second lens 200 may include a second protrusion 220. The second protrusion 220 may be disposed on the lower surface of the flange portion. The second protrusion 220 may have a trapezoidal cross-section, parallel to the optical axis. The width of the second protrusion 220 may become narrower in the direction from the second lens 200 to the first lens 100. The second protrusion 220 may have a tapered shape whose width becomes narrower in the direction from the second lens 200 to the first lens 100.

The second protrusion 220 may include a first outer surface 221 and a second outer surface 222. The first outer surface 221 and the second outer surface 222 may be side surfaces of the second protrusion 220. The first outer surface 221 may be disposed opposite to the second outer surface 222. The first outer surface 221 and the second outer surface 222 may overlap in a first direction perpendicular to the optical axis. The first outer surface 221 and the second outer surface 222 may be inclined surfaces. The distance of the first outer surface 221 from the optical axis may increase as it extends in a direction from one surface of the flange portion to the other surface. The distance of the second outer surface 222 from the optical axis may become shorter as it extends in a direction from the one surface of the flange portion to the other surface.

The second protrusion 220 may include a third outer surface 223. The third outer surface 223 may be a surface connecting the first outer surface 221 and the second outer surface 222. The third outer surface 223 may be a plane perpendicular to the optical axis.

Referring to FIGS. 1 and 2, the third lens 300 may be disposed below the first lens 100. The third lens 300 may include an optical portion and a flange portion extending from the optical portion. At least a portion of the flange portion of the third lens 300 may contact the flange portion of the first lens 100. The flange portion of the third lens 300 may include a second groove 310. The second groove 310 may be disposed on an upper surface of the third lens 300. In this case, the upper surface of the third lens 300 may be the surface closest to the first lens 100 among one surface and the other surface of the third lens 300. The second groove 310 may have a trapezoidal shape in a cross-section parallel to the optical axis. The width of the second groove 310 may become narrower in the direction from the first lens 100 to the third lens 300. The second groove 310 may have a tapered shape whose width becomes narrower in the direction from the first lens 100 to the third lens 300.

The second groove 310 may include a first inner surface 311 and a second inner surface 312. The first inner surface 311 and the second inner surface 312 may be side surfaces of the second groove 310. The first inner surface 311 may be disposed opposite to the second inner surface 312. The first inner surface 311 may overlap the second inner surface 312 in a first direction perpendicular to the optical axis. The first inner surface 311 and the second inner surface 312 may be inclined surfaces. The first inner surface 311 may be an inclined surface whose distance from the optical axis increases as it extends from one surface of the flange portion to the other surface. The second inner surface 312 may be an inclined surface whose distance from the optical axis becomes shorter as it extends from the one surface of the flange portion to the other surface.

The second groove 310 may include a third inner surface 313. The third inner surface 313 may be the lower surface of the second groove 310. The third inner surface 313 may be a surface connecting the first inner surface 311 and the second inner surface 312. The third inner surface 313 may be flat. The third inner surface 313 may be a plane perpendicular to the optical axis.

FIG. 2 is an enlarged view of A in FIG. 1 when the lens is not expanded. Referring to FIG. 2, a structure in which the first lens is spaced apart from the second lens, the third lens, or a lens barrel will be described.

Referring to FIG. 2, a second protrusion 220 may be disposed in the first groove 110. The second protrusion 220 may be inserted into the first groove 110. The second protrusion 220 may be spaced apart from a portion of the inner surface of the first groove 110 in a first direction perpendicular to the optical axis. A separation space may be formed between the inner surface of the first groove 110 and the outer surface of the second protrusion 220. A gap may be disposed between the inner surface of the first groove 110 and the outer surface of the second protrusion 220.

The first inner surface 111 of the first groove 110 and the first outer surface 221 of the second protrusion 220 may face each other. The first inner surface 111 of the first groove 110 and the first outer surface 221 of the second protrusion may overlap in a first direction perpendicular to the optical axis. The first inner surface 111 of the first groove 110 and the first outer surface 221 of the second protrusion 220 may be substantially parallel to each other. The first inner surface 111 of the first groove 110 and the first outer surface 221 of the second protrusion 220 may be spaced apart from each other. The first inner surface 111 of the first groove 110 and the first outer surface 221 of the second protrusion 220 may be spaced apart in an optical axis direction, a direction perpendicular to the optical axis, or a direction inclined to the optical axis.

The second inner surface 112 of the first groove 110 and the second outer surface 222 of the second protrusion 220 may face each other. The second inner surface 112 of the first groove 110 and the second outer surface 222 of the second protrusion 220 may overlap in a direction perpendicular to the optical axis. The second inner surface 112 of the first groove 110 and the second outer surface 222 of the second protrusion 220 may be substantially parallel to each other. The second inner surface 112 of the first groove 110 and the second outer surface 222 of the second protrusion 220 may be in contact.

The third inner surface 113 of the first groove 110 and the third outer surface 223 of the second protrusion 220 may face each other. The third inner surface 113 of the first groove 110 and the third outer surface 223 of the second protrusion 220 may be parallel to each other. The third inner surface 113 of the first groove 110 and the third outer surface 223 of the second protrusion 220 may be spaced apart from each other. The third inner surface 113 of the first groove 110 and the third outer surface 223 of the second protrusion 220 may be spaced apart in the optical axis direction.

Referring to FIG. 2, the first protrusion 120 may be disposed in the second groove 310. The first protrusion 120 may be inserted into the second groove 310. The first protrusion 120 may be spaced apart from a portion of the inner surface of the second groove 310 in a first direction perpendicular to the optical axis. The inner surface of the second groove 310, which is spaced apart from the first protrusion 120 in a first direction perpendicular to the optical axis, may be spaced apart from the inner surface of the first groove 110, which is spaced apart from the second protrusion 220 in a first direction perpendicular to the optical axis, in the first direction perpendicular to the optical axis. A portion of the inner surface of the first groove 110 spaced apart from the second protrusion 220 in the first direction may be disposed closer to the optical axis than a portion of the inner surface of the second groove 310 spaced apart from the first protrusion 120 in the first direction.

A separation space may be formed between the inner surface of the second groove 310 and the outer surface of the first protrusion 120. A gap may be disposed between the inner surface of the second groove 310 and the outer surface of the first protrusion 120. The separation space formed between the inner surface of the second groove 310 and the outer surface of the first protrusion 120 may be spaced apart from a separation space formed between the inner surface of the first groove 110 and the outer surface of the second protrusion 220, in the first direction perpendicular to the optical axis.

The first inner surface 311 of the second groove 310 and the first outer surface 121 of the first protrusion 120 may face each other. The first inner surface 311 of the second groove 310 and the first outer surface 121 of the first protrusion 120 may overlap in a first direction perpendicular to the optical axis. The first inner surface 311 of the second groove 310 and the first outer surface 121 of the first protrusion 120 may be parallel. The first inner surface 311 of the second groove 310 and the first outer surface 121 of the first protrusion 120 may be in contact.

The second inner surface 312 of the second groove 310 and the second outer surface 122 of the first protrusion 120 may face each other. The second inner surface 312 of the second groove 310 and the second outer surface 122 of the first protrusion 120 may overlap in a direction perpendicular to the optical axis. The second inner surface 312 of the second groove 310 and the second outer surface 122 of the first protrusion 120 may be parallel to each other. The second inner surface 312 of the second groove 310 and the second outer surface 122 of the first protrusion 120 may be spaced apart from each other. The second inner surface 312 of the second groove 310 and the second outer surface 122 of the first protrusion 120 may be spaced apart in the optical axis direction, a direction perpendicular to the optical axis, or a direction inclined to the optical axis.

The third inner surface 313 of the second groove 310 and the third outer surface 123 of the first protrusion 120 may face each other. The third inner surface 313 of the second groove 310 and the third outer surface 123 of the first protrusion 120 may be parallel to each other. The third inner surface 313 of the second groove 310 and the third outer surface 123 of the first protrusion 120 may be spaced apart from each other. The third inner surface 313 of the second groove 310 and the third outer surface 123 of the first protrusion 120 may be spaced apart in the optical axis direction.

Referring to FIG. 2, the outer peripheral surface of the first lens 100 may be spaced apart from the inner peripheral surface of the lens barrel 20. The outer peripheral surface of the second lens 200 may contact the inner peripheral surface of the lens barrel 20. The outer peripheral surface of the third lens 300 may contact the inner peripheral surface of the lens barrel 20.

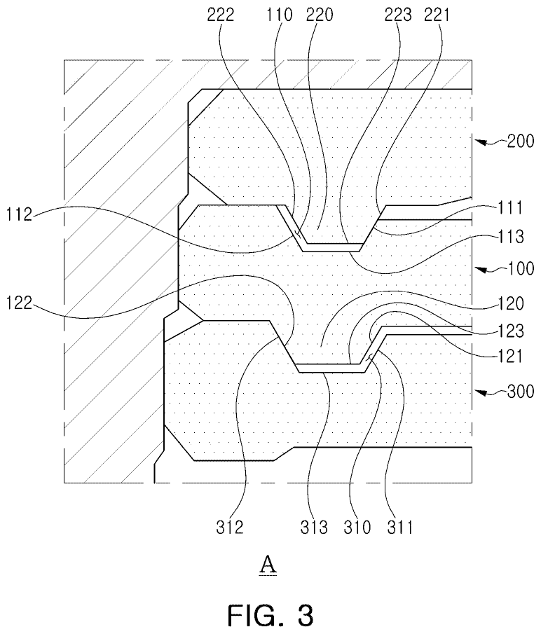

FIG. 3 is an enlarged view of A in FIG. 1 when the first lens is expanded. Referring to FIG. 3, the first lens 100 may expand in a direction perpendicular to the optical axis. Under specific temperature or humidity conditions, the expansion amount of the first lens 100 may be greater than expansion amounts of the second lens 200 and the third lens 300. As the first lens 100 expands in a direction perpendicular to the optical axis, the region in which the first lens 100 contacts the second lens 200 or the third lens 300 may change. When the first lens 100 expands, the first groove 110 and the first protrusion 120 may move in a direction perpendicular to the optical axis. When the first lens 100 expands, the first groove 110 and the first protrusion 120 may move radially outward of the first lens 100.

Referring to FIG. 3, the first inner surface 111 of the first groove 110 and the first outer surface 221 of the second protrusion 120 may contact each other. On the other hand, the second inner surface 112 of the first groove 110 and the second outer surface 222 of the second protrusion 120 may be spaced apart from each other.

The second inner surface 312 of the second groove 310 and the second outer surface 122 of the first protrusion 120 may contact each other. On the other hand, the first inner surface 311 of the second groove 310 and the first outer surface 121 of the first protrusion 120 may be spaced apart from each other.

Additionally, the outer peripheral surface of the first lens 100 may contact the inner peripheral surface of the lens barrel 20.

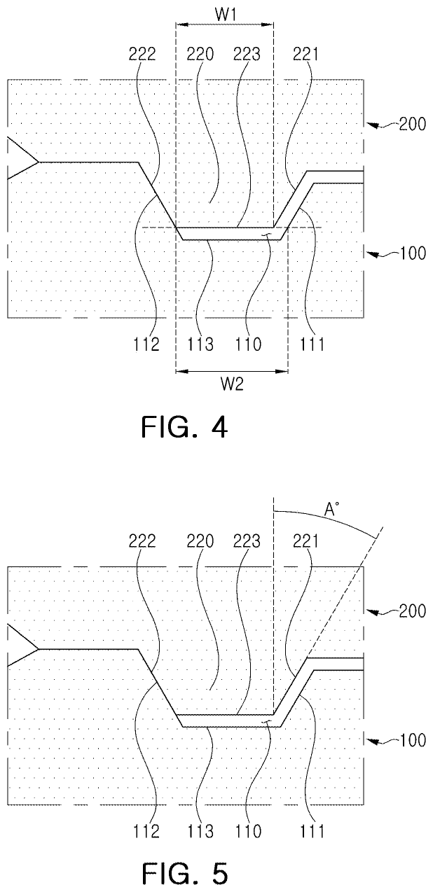

FIGS. 4 and 5 are enlarged views of portions of the first lens and the second lens when the first lens is not expanded. FIGS. 4 and 5 are illustrated and described based on the first groove and the second protrusion for explanation, but the same content may be applied to the second groove and the first protrusion.

Referring to FIG. 4, the second protrusion 220 and the first groove 110 may be spaced apart from each other. A separation distance (W2-W1) between the second protrusion 220 and the first groove 110 may be defined based on a case in which a portion of the outer surface of the second protrusion 220 and a portion of the inner surface of the first groove 110 are in contact. In the case in which a portion of the outer surface of the second protrusion 220 and a portion of the inner surface of the first groove 110 come into contact, a distance at which the second protrusion 220 is spaced apart from the first groove 110 in the direction perpendicular to the optical axis may be defined as the distance (W2-W1). The separation distance between the second protrusion 220 and the first groove 110 may be determined in advance when manufacturing the lens.

The separation distance between the second protrusion 220 and the first groove 110 may be determined by considering the amount of expansion of the lens due to moisture absorption. For example, if a first reference state is a state in which the relative humidity in the atmosphere is not saturated, and a second reference state is a state in which the relative humidity in the atmosphere is saturated, when the first reference state changes to the second reference state, the separation distance (W2-W1) between the protrusion and the groove may be determined by considering the amount of expansion of the first lens 100. For example, if the outer diameter range of the first lens 100 is 1 to 8 mm and the expansion amount of the lens when changing from the first reference state to the second reference state is about 0.001 times the outer diameter of the lens, the separation distance between the second protrusion 220 and the first groove 110 may be determined to be within a range greater than 1 μm and less than 8 μm. When the first inner surface 111 of the first groove 110 and the first outer surface 221 of the second protrusion 220 are spaced apart in the first reference state, the first lens 100 may expand in the second reference state and thus the second inner surface 112 of the first groove 110 and the second outer surface 122 of the second protrusion 120 may be spaced apart from each other.

Referring to FIG. 5, the first outer surface 221 or the second outer surface 222 of the second protrusion 220 may form an acute angle with a virtual line parallel to the optical axis. If the length of the third outer surface 223 of the second protrusion 220 is under the same conditions, the volume of the second protrusion 220 may increase as the acute angle increases. The angle of the acute angle may be determined by considering the amount of deformation of the lenses when contact between lenses occurs. Additionally, the angle of the acute angle may be determined by considering the assembly stability of the lens. For example, the range of the acute angle may vary depending on the design and assembly conditions of the lens. For example, the acute angle may range from 10° to 35°.

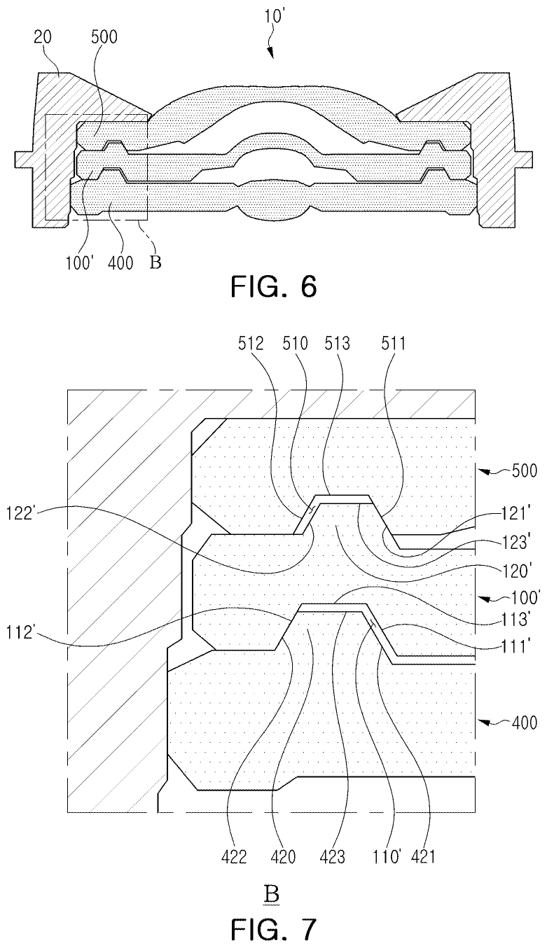

FIG. 6 is a cross-sectional view of a lens module to which a lens assembly according to another embodiment is applied, and FIG. 7 is an enlarged view of B of FIG. 6 when the lens is not expanded. Hereinafter, descriptions of the same content as the embodiments of FIGS. 1 to 5 may be omitted, and differences may be described.

A first lens 100′, a second lens 400, and a third lens 500 may be disposed inside a lens barrel 20. The lens barrel 20 may accommodate the lens assembly 10′ including the first lens 100′, the second lens 400, and the third lens 500.

The first lens 100′ may include a first groove 110′ and a first protrusion 120′. The first groove 110′ may be formed on the lower surface of the first lens 100′, and the first protrusion 120′ may be disposed on the upper surface of the first lens 100′. A second lens 400 may include a second protrusion 420. The second protrusion 420 may be disposed on the upper surface of the second lens 400. A third lens 500 may include a second groove 510. The second groove 510 may be formed on the lower surface of the third lens 500.

The first protrusion 120′ may be disposed in the second groove 510. The first outer surface 121′ of the first protrusion 120′ and the first inner surface 511 of the second groove 510 may be in contact. The second outer surface 122′ of the first protrusion 120′ and the second inner surface 512 of the second groove 510 may be spaced apart from each other.

The second protrusion 420 may be disposed in the first groove 110′. The second outer surface 422 of the second protrusion 420 and the second inner surface 112′ of the first groove 110′ may be in contact. The first outer surface 421 of the second protrusion 420 and the first inner surface 111′ of the first groove 110′ may be spaced apart from each other.

The first groove 110′ may include a third inner surface 113′. The third inner surface 113′ may be the upper surface of the first groove 110′. The third inner surface 113′ may be a surface connecting the first inner surface 111′ and the second inner surface 112′. The third inner surface 113′ may be flat. The third inner surface 113′ may be a plane perpendicular to the optical axis.

The first protrusion 120′ may include a third outer surface 123′. The third outer surface 123′ may be a surface connecting the first outer surface 121′ and the second outer surface 122′. The third outer surface 123′ may be a plane perpendicular to the optical axis.

The second protrusion 420 may include a third outer surface 423. The third outer surface 423 may be a surface connecting the first outer surface 421 and the second outer surface 422. The third outer surface 423 may be a plane perpendicular to the optical axis.

The second groove 510 may include a third inner surface 513. The third inner surface 513 may be the upper surface of the second groove 510. The third inner surface 513 may be a surface connecting the first inner surface 511 and the second inner surface 512. The third inner surface 513 may be flat. The third inner surface 513 may be a plane perpendicular to the optical axis.

The third inner surface 113′ of the first groove 110′ and the third outer surface 423 of the second protrusion 420 may face each other. The third inner surface 113′ of the first groove 110′ and the third outer surface 423 of the second protrusion 420 may be parallel to each other. The third inner surface 113′ of the first groove 110′ and the third outer surface 423 of the second protrusion 420 may be spaced apart from each other. The third inner surface 113′ of the first groove 110′ and the third outer surface 423 of the second protrusion 420 may be spaced apart in the optical axis direction.

The third inner surface 513 of the second groove 510 and the third outer surface 123′ of the first protrusion 120′ may face each other. The third inner surface 513 of the second groove 510 and the third outer surface 123′ of the first protrusion 120′ may be parallel to each other. The third inner surface 513 of the second groove 510 and the third outer surface 123′ of the first protrusion 120′ may be spaced apart from each other. The third inner surface 513 of the second groove 510 and the third outer surface 123′ of the first protrusion 120′ may be spaced apart in the optical axis direction.

The first lens 100′ may expand in a direction perpendicular to the optical axis. Under specific temperature or humidity conditions, the expansion amount of the first lens 100′ may be greater than the expansion amount of the second lens 400 or the third lens 500. As the first lens 100′ expands in the direction perpendicular to the optical axis, the first outer surface 121′ of the first protrusion 120′ and the first inner surface 511 of the second groove 510 are spaced apart, and the second outer surface 122′ of the first protrusion 120′ may be in contact with the second inner surface 512 of the second groove 510.

In addition, as the first lens 100′ expands in the direction perpendicular to the optical axis, the second outer surface 422 of the second protrusion 420 and the second inner surface 112′ of the first groove 110′ are spaced apart, and the first outer surface 421 of the second protrusion 420 and the first inner surface 111′ of the first groove 110′ may be in contact.

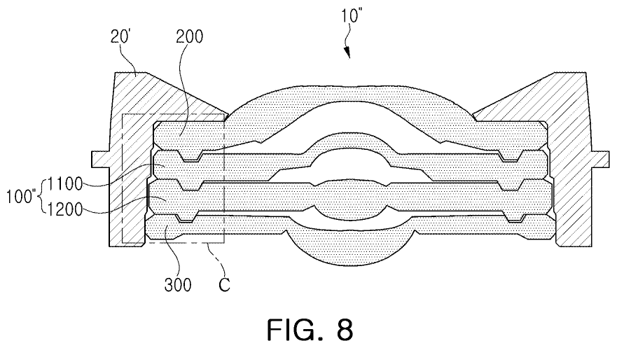

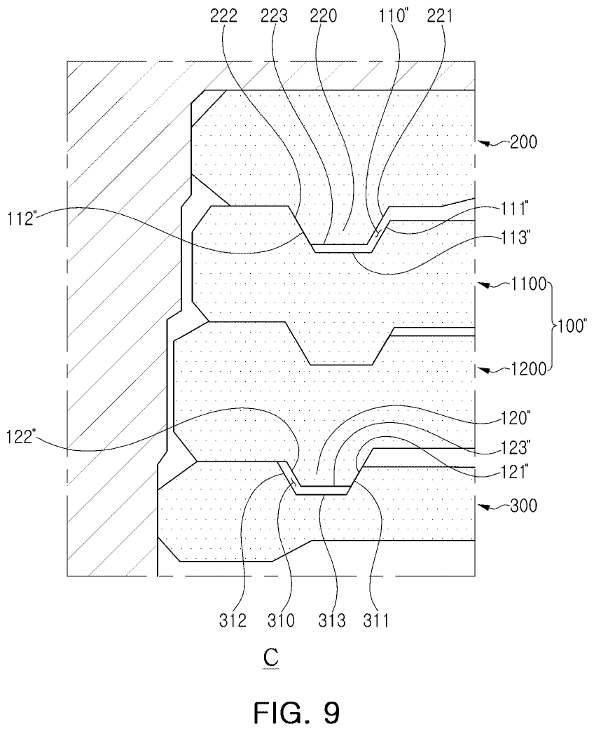

FIG. 8 is a cross-sectional view of a lens module to which a lens assembly according to another embodiment is applied, and FIG. 9 is an enlarged view of C of FIG. 8 when the lens is not expanded. Hereinafter, descriptions of the same content as the embodiments of FIGS. 1 to 5 may be omitted, and differences may be described.

A first lens 100″, a second lens 200, and a third lens 300 may be disposed inside a lens barrel 20′. The lens barrel 20′ may accommodate the lens assembly 10″ including the first lens 100″, the second lens 200, and the third lens 300.

The first lens 100″ may include an upper first lens 1100 and a lower first lens 1200. The upper first lens 1100 and the lower first lens 1200 may be stacked. The upper first lens 1100 and the lower first lens 1200 may each include a flange portion. A protrusion or a groove may be disposed on the flange portions of the upper first lens 1100 and the lower first lens 1200, and the protrusion may be fitted into the groove.

The first lens 100″ may include a first groove 110″ and a first protrusion 120″. The first groove 110″ may be formed on the upper surface of the upper first lens 1100, and the first protrusion 120″ may be disposed on the lower surface of the lower first lens 1200. A second lens 200 may include a second protrusion 220. The second protrusion 220 may be formed on the lower surface of the second lens 200. A third lens 300 may include a second groove 310. The second groove 310 may be disposed on the upper surface of the third lens 300.

The first protrusion 120″ may be disposed in the second groove 310. The first outer surface 121″ of the first protrusion 120″ and the first inner surface 311 of the second groove 310 may be in contact. The second outer surface 122″ of the first protrusion 120″ and the second inner surface 312 of the second groove 310 may be spaced apart from each other.

The second protrusion 220 may be disposed in the first groove 110″. The second outer surface 222 of the second protrusion 220 and the second inner surface 112″ of the first groove 110″ may be in contact. The first outer surface 221 of the second protrusion 220 and the first inner surface 111″ of the first groove 110″ may be spaced apart from each other.

The first groove 110″ may include a third inner surface 113″. The third inner surface 113″ may be the lower surface of the first groove 110″. The third inner surface 113″ may be a surface connecting the first inner surface 111″ and the second inner surface 112″. The third inner surface 113″ may be flat. The third inner surface 113″ may be a plane perpendicular to the optical axis.

The first protrusion 120″ may include a third outer surface 123″. The third outer surface 123″ may be a surface connecting the first outer surface 121″ and the second outer surface 122″. The third outer surface 123″ may be a plane perpendicular to the optical axis.

The third inner surface 113″ of the first groove 110″ and the third outer surface 223 of the second protrusion 220 may face each other. The third inner surface 113″ of the first groove 110″ and the third outer surface 223 of the second protrusion 220 may be parallel to each other. The third inner surface 113″ of the first groove 110″ and the third outer surface 223 of the second protrusion 220 may be spaced apart from each other. The third inner surface 113″ of the first groove 110″ and the third outer surface 223 of the second protrusion 220 may be spaced apart in the optical axis direction.

The third inner surface 313 of the second groove 310 and the third outer surface 123″ of the first protrusion 120″ may face each other. The third inner surface 313 of the second groove 310 and the third outer surface 123″ of the first protrusion 120″ may be parallel to each other. The third inner surface 313 of the second groove 310 and the third outer surface 123″ of the first protrusion 120″ may be spaced apart from each other. The third inner surface 313 of the second groove 310 and the third outer surface 123″ of the first protrusion 120″ may be spaced apart in the optical axis direction.

The first lens 100″ may expand in a direction perpendicular to the optical axis. Under specific temperature or humidity conditions, the expansion amount of the first lens 100″ may be greater than the expansion amount of the second lens 200 or the third lens 300. As the first lens 100″ expands in the direction perpendicular to the optical axis, the first outer surface 121″ of the first protrusion 120 may be spaced apart from the first inner surface 311 of the second groove 310 and the second outer surface 122″ of the first protrusion 120″ may be in contact with the second inner surface 312 of the second groove 310.

In addition, as the first lens 100″ expands in the direction perpendicular to the optical axis, the second outer surface 222 of the second protrusion 220 and the second inner surface 112″ of the first groove 110″ may be spaced apart, and the first outer surface 221 of the second protrusion 220 and the first inner surface 111″ of the first groove 110″ may be in contact.

In the case of the above embodiments, before the first lens 100, 100′, 100″ expands, the surface where the first protrusion 120, 120′, 120″ of the first lens 100, 100′, 100″ contacts the second groove 310, 510 may be placed inside or outside in the first lens 100, 100′, 100″ in the radial direction, as compared to the surface where the first groove 110, 110′, 110″ of the first lens 100, 100′, 100″ contacts the second protrusion 220, 420. In this case, when the first lens 100, 100′, 100″ expands, the surface where the first protrusion 120, 120′, 120″ of the first lens 100, 100′, 100″ contacts the second groove 310, 510 may be placed outside or inside in the first lens 100, 100′, 100″ in the radial direction, as compared to the surface where the first groove 110, 110′, 110″ of the first lens 100, 100′, 100″ contacts the second protrusion 220, 420.

Accordingly, the first lens 100, 100′, 100″ may be fitted with the second lens 200, 400 and the third lens 300, 500 before and after the first lens is expanded by moisture or heat. Additionally, in the case in which the first lens 100, 100′, 100″ expands in the radial direction due to moisture or heat, deformation of the first lens 100, 100′, 100″, the second lens 200, 400, and the third lens 300, 500 caused by interference between the first lens 100, 100′, 100″ and the second lens 200, 400 or the third lens 300, 500 may be significantly reduced, and the first lens 100, 100′, 100″ may be fitted with the second lens 200, 400 and the third lens 300, 500. Therefore, even when the first lens 100, 100′, 100″ is expanded and deformed in the radial direction, the occurrence of deformation due to contact between the first lens 100, 100′, 100″, the second lens 200, 400, and the third lens 300, 500 may be significantly reduced, and a decrease in the performance of the lens assembly due to changes in the shape of the optical portions of the first lens 100, 100′, 100″, the second lens 200, 400 and the third lens 300, 500 or changes in the distance between the first lens 100, 100′, 100″, the second lens 200, 400, and the third lens 300, 500 may be significantly reduced.

As set forth above, with a lens assembly according to an embodiment, lens deformation due to contact between lenses may be significantly reduced, and a decrease in performance of the lens assembly due to changes in the shape of an optical portion of the lens or changes in distance between the lenses may be significantly reduced.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A lens assembly comprising:
a first lens comprising an optical portion and a flange portion extending from the optical portion;
a second lens disposed on one side of the first lens in an optical axis direction; and
a third lens disposed on another side of the first lens in the optical axis direction,
wherein the flange portion comprises a first groove formed in one surface and a first protrusion disposed on another surface,
wherein the second lens comprises a second protrusion disposed in the first groove,
wherein the third lens comprises a second groove in which the first protrusion is disposed, and
wherein the second protrusion is spaced apart from a portion of an inner surface of the first groove in a first direction, perpendicular to an optical axis, the first protrusion is spaced apart from a portion of an inner surface of the second groove in the first direction, and the portion of the inner surface of the first groove is disposed closer to the optical axis than the portion of the inner surface of the second groove.

2. The lens assembly of claim 1, wherein the first groove comprises a first inner surface and a second inner surface spaced apart in the first direction, and
wherein the second protrusion is disposed to be spaced apart from the first inner surface of the first groove.

3. The lens assembly of claim 2, wherein the second groove comprises a first inner surface and a second inner surface spaced apart in the first direction, and
wherein the first protrusion is disposed to be spaced apart from the second inner surface of the second groove.

4. The lens assembly of claim 3, wherein the first inner surface of the first groove is disposed further inwardly of the second inner surface of the second groove in the first direction.

5. The lens assembly of claim 2, wherein the inner surface of the first groove comprises a third inner surface connecting the first inner surface of the first groove and the second inner surface of the first groove,
wherein a lower surface of the second protrusion opposes the third inner surface of the first groove, and
wherein the lower surface of the second protrusion is spaced apart from the third inner surface of the first groove in the optical axis direction.

6. The lens assembly of claim 1, wherein the first protrusion has a tapered shape with a width becoming narrower from an object side to an image side.

7. The lens assembly of claim 6, wherein the first protrusion comprises a first outer surface in contact with the second groove,
wherein the first outer surface forms an acute angle with a virtual line parallel to the optical axis.

8. The lens assembly of claim 1, wherein an amount of expansion of the first lens in the first direction according to a change in temperature or humidity is greater than an amount of expansion of the second lens and the third lens in the first direction.

9. The lens assembly of claim 1, wherein the one surface of the flange portion is an image-side surface, and the other surface of the flange portion is an object-side surface.

10. The lens assembly of claim 9, wherein the first groove comprises a first inner surface and a second inner surface opposing the first inner surface of the first groove, and
wherein the second protrusion is disposed to be spaced apart from the first inner surface of the first groove in the first direction.

11. The lens assembly of claim 10, wherein the second groove comprises a first inner surface and a second inner surface opposing the first inner surface of the second groove, and
the first protrusion is disposed to be spaced apart from the second inner surface of the second groove in the first direction.

12. The lens assembly of claim 9, wherein the first protrusion has a tapered shape with a width becoming narrower from an image side to an object side.

13. The lens assembly of claim 1, wherein the first lens comprises an upper first lens and a lower first lens stacked.

14. A lens assembly comprising:
a lens barrel;
a first lens comprising an optical portion and a flange portion extending from the optical portion;
a second lens disposed on one side of the first lens in an optical axis direction; and
a third lens disposed on another side of the first lens in the optical axis direction,
wherein the flange portion comprises a first groove formed in one surface and a first protrusion disposed on another surface,
wherein the second lens comprises a second protrusion disposed in the first groove,
wherein the third lens comprises a second groove in which the first protrusion is disposed,
wherein the first groove comprises a first inclined surface spaced apart from the second protrusion in a first direction, perpendicular to an optical axis,
wherein the second groove comprises a second inclined surface spaced apart from the first protrusion in the first direction, and
wherein the first inclined surface of the first groove and the second inclined surface of the second groove have inclined directions opposite to each other based on a line, parallel to the optical axis.

15. The lens assembly of claim 14, wherein an outer peripheral surface of the first lens is spaced apart from an inner peripheral surface of the lens barrel.

16. The lens assembly of claim 15, wherein the first lens is configured to expand in the first direction according to a change in temperature or humidity such that the outer peripheral surface of the first lens contacts the inner peripheral surface of the lens barrel.

17. The lens assembly of claim 15, wherein the first lens is configured to expand in the first direction according to a change in temperature or humidity such that the first protrusion contacts the second inclined surface of the second groove.
